(19) United States
(12) Patent Application Publication
(10) Pub. No.: US 2022/0410820 A1
(43) Pub. Date: Dec. 29, 2022

(54) ROCKER MOLDING

(71) Applicant: TOYOTA JIDOSHA KABUSHIKI KAISHA, Toyota-shi Aichi-ken (JP)

(72) Inventor: Yasuyuki Hihara, Nagoya-shi Aichi-ken (JP)

(73) Assignee: TOYOTA JIDOSHA KABUSHIKI KAISHA, Toyota-shi Aichi-ken (JP)

(21) Appl. No.: 17/842,180

(22) Filed: Jun. 16, 2022

(30) Foreign Application Priority Data
Jun. 23, 2021 (JP) 2021-103928

(51) Int. Cl. B60R 13/04

(52) U.S. Cl. CPC B60R 13/04

(57) ABSTRACT

Provided is a rocker molding composed of a front rocker molding piece to be mounted on the front side of a vehicle in the front-rear direction and a rear rocker molding piece to be mounted on the rear side. The rocker molding may be made of resin. The front rocker molding piece has an extension portion C formed on its rear end portion. The extension portion C extends inward in the vehicle width direction. The rear rocker molding piece has a recessed portion into which the extension portion is to be inserted.

### CROSS REFERENCE TO RELATED APPLICATION

This application claims priority to Japanese Patent Application No. 2021-103928 filed on Jun. 23, 2021, which is incorporated herein by reference in its entirety including the specification, claims, drawings, and abstract.

### TECHNICAL FIELD

The present disclosure relates to the structure of a rocker molding of a vehicle.

### BACKGROUND

A vehicle has a rocker panel, which is mounted on the lower lateral side of its body so as to extend in the front-rear direction of the vehicle, and a rocker molding, which is mounted outside the rocker panel in the vehicle width direction. The rocker molding is an integrally formed accessory component, and can improve aerodynamic performance and designability of the vehicle. For example, JP2005-053419A discloses a rocker molding that is composed of an inner portion and an outer portion in the vehicle width direction.

### SUMMARY

A rocker molding for large-scale vehicles, for example, is molded into a very longitudinal shape to be mounted on a vehicle so as to extend in the front-rear direction of the vehicle. Molding such a long rocker molding requires a large-scale molding machine, which increases manufacturing cost. Moreover, such a long rocker molding is not readily assembled onto a vehicle, that is, it has poor workability.

In view of the above, the present disclosure aims to provide a rocker molding with superior workability in assembling without increase in manufacturing cost.

According to one aspect of the present disclosure, there is provided a rocker molding to be mounted on a vehicle so as to extend in the front-rear direction of the vehicle, wherein the rocker molding is composed of a front rocker molding piece to be mounted on the front side in the front-rear direction of the vehicle, and a rear rocker molding piece to be mounted on the rear side.

In some embodiments, the rocker molding according to this disclosure may be made of resin.

In some embodiments, the front rocker molding piece may have an extension portion formed on the rear end portion thereof, the extension portion extending inward in the width direction of the vehicle, and the rear rocker molding piece may have a recessed portion into which the extension portion is to be inserted.

The rocker molding according to the present disclosure can improve workability in assembling the rocker molding without increasing manufacturing cost.

### BRIEF DESCRIPTION OF DRAWINGS

Embodiment(s) of the present disclosure will be described based on the following figures, wherein:

FIG. 1 is a side view of a vehicle equipped with a rocker molding according to an embodiment;

FIG. 2 is a side view of an exemplary rocker molding according to the embodiment and an enlarged perspective view of the portion A; and

FIG. 3 is a cross sectional view along the line BB in FIG. 2.

### DESCRIPTION OF EMBODIMENTS

One example of an embodiment of this disclosure will now be described in detail. Note that specific shapes, materials, directions, and numeric values, or the like referred to in the description below are only examples to help understanding of this disclosure, and can be arbitrarily modified depending on use, purpose, specifications, and so forth.

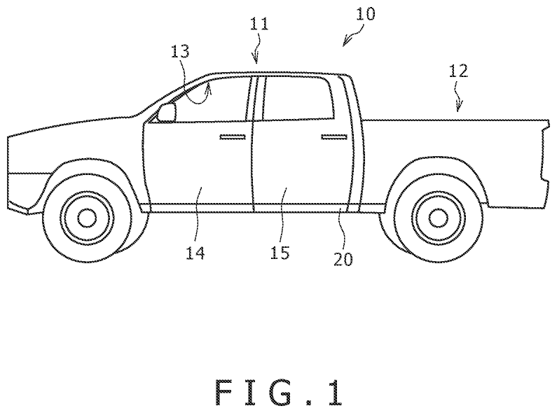

Referring to FIG. 1, a vehicle 10 having a rocker molding 20 according to an embodiment will be described. FIG. 1 is a side view of the vehicle 10.

The vehicle 10 is a four-wheeled automatic vehicle having a cabin 11. Specifically, the vehicle 10 is a pick-up truck, for example, having an open loading platform 12 behind the cabin 11. Note that the vehicle 10 may be any vehicle having a cabin 11, without limitation to a pickup truck.

The cabin 11 has a lateral opening 13 defined on its lateral surface. A front door 14 and a rear door 15 are attached in the lateral opening 13. Below the front door 14 and the rear door 15, a rocker panel, not illustrated, is provided, which constitutes a framework in the front-rear direction of the vehicle. The rocker panel is a frame constituting the lower portion of the lateral opening 13 as well as both right and left lateral portions of the cabin 11. The rocker panel is mounted on the vehicle so as to extend in the front-rear direction.

Outside the rocker panel in the vehicle width direction, a rocker molding 20 is mounted. The rocker molding 20 is an accessory component that is integrally molded from resin material. The rocker molding 20 can improve aerodynamic performance and designability of the vehicle 10.

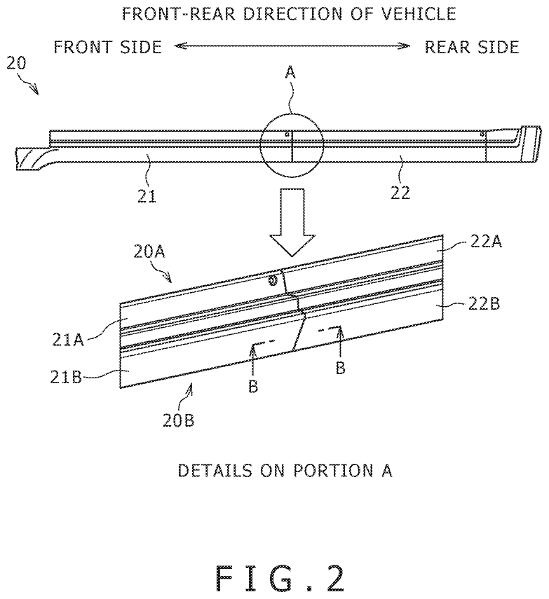

Referring to FIG. 2, an exemplary rocker molding 20 according to this embodiment will be described. FIG. 2 is a side view of the rocker molding 20 and an enlarged perspective view of the portion A.

The rocker molding 20 is composed of a front rocker molding piece 21 and a rear rocker molding piece 22. The front rocker molding piece 21 is provided on the front side in the front-rear direction of the vehicle, while the rear rocker molding piece 22 is provided on the rear side. In other words, the rocker molding 20 is separated into the front rocker molding piece 21 and the rear rocker molding piece 22 substantially at its middle in the front-rear direction of the vehicle.

A rocker molding 20 for a large-scaled vehicle 10, such as a pick-up truck, is molded to have a very longitudinal shape to be mounted on the vehicle along the front-rear direction. Molding such a long rocker molding 20 requires a large-scaled molding machine, which increases the manufacturing cost.

In view of the above, the rocker molding 20 according to this embodiment is composed of the front rocker molding piece 21 and the rear rocker molding piece 22, which are to be mounted on the vehicle along the front-rear direction of the vehicle. This structure does not require a large-scaled molding machine, but can be molded with a traditional molding machine with a die changed to a suitable die. This can avoid increase in manufacturing cost.

In addition, assembling such a very long rocker molding 20 onto a rocker panel by an operator when manufacturing the vehicle 10 is troublesome, for example, in carrying the rocker molding 20 and adjusting the position of the rocker molding 20 relative to the rocker panel. Further, such a very long rocker molding 20 requires a large long space to store the rocker molding 20 at a manufacturing site.

Use of the rocker molding 20 according to this embodiment, which is composed of the front rocker molding piece 21 and the rear rocker molding piece 22 to be assembled and mounted on a vehicle along the front-rear direction, can improve workability when assembling the rocker molding 20 by an operator, for example, in carrying the rocker molding 20 and adjusting the position of the rocker molding 20 relative to the rocker panel. Further, as the rocker molding 20 can be separated into two pieces, namely, the front rocker molding piece 21 and the rear rocker molding piece 22, before being stored, the rocker molding 20 can be stored in a smaller space at a manufacturing site.

The boundary between the front rocker molding piece 21 and the rear rocker molding piece 22 of the rocker molding 20 coincides with the boundary between the front door 14 and the rear door 15 in the front-rear direction of the vehicle. In other words, the rear end portion of the front rocker molding piece 21 (that is, the rear end portion of an extension portion 21C, to be described later) coincides with the boundary between the front door 14 and the rear door 15 in the front-rear direction of the vehicle.

The above-described structure can improve designability of the vehicle 10. Further, the boundary between the front door 14 and the rear door 15 can be used as a reference in positioning when assembling and mounting the front rocker molding piece 21 and the rear rocker molding piece 22.

Moreover, an integrally formed resin rocker molding, such as the rocker molding 20 in this example, is adaptable to variations in design.

The rocker molding 20 is composed of a stepped portion 20A and an inclined portion 20B. The stepped portion 20A is formed on the upper half of the rocker molding 20 so as to extend, while being stepped, inward and upward in the vehicle width direction. Meanwhile, the inclined portion 20B is formed on the lower half of the rocker molding 20 so as to extend, while being inclined, inward and downward in the vehicle width direction. Accordingly, the front rocker molding piece 21 is composed of a stepped portion 21A similarly formed on its upper half and an inclined portion 21B similarly formed on its lower half, and the rear rocker molding piece 22 is composed of a stepped portion 22A similarly formed on its upper half, and an inclined portion 22B similarly formed on its lower half.

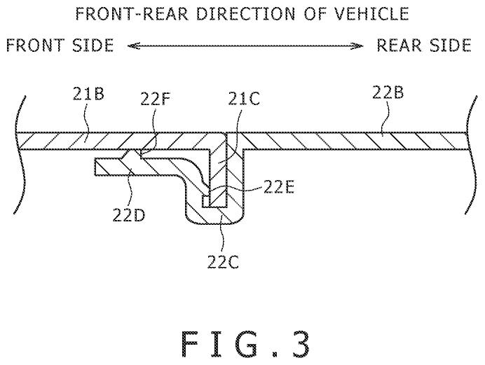

Referring to FIG. 3, a structure for securing the joint portion of the rocker molding 20 will be described. FIG. 3 is a cross sectional view along the line BB in FIG. 2, viewed up from below.

As illustrated in FIG. 3, the inclined portion 21B of the front rocker molding piece 21 has an extension portion 21C formed on its rear end portion. In detail, a part of the rear end portion of the inclined portion 21B of the front rocker molding piece 21 is bent inward to thereby form the extension portion 21C.

Meanwhile, the inclined portion 22B of the rear rocker molding piece 22 has a recessed portion 22C formed on its front end portion, into which the extension portion 21C is to be inserted. Further, the recessed portion 22C has an extension portion 22D that is formed on its front side and extends adjacent to the inner surface of the inclined portion 21B of the front rocker molding piece 21.

A rib 22E is formed on the front wall of the recessed portion 22C, for urging the extension portion 21C. Being urged by the rib 22E, the extension portion 21C is securely fitted in the recessed portion 22C. Further, a rib 22F is formed on the outside surface of the extension portion 22D, for urging the inclined portion 21B. With the above, the inclined portion 21B of the front rocker molding piece 21 is firmly pressed by the rib 22F.

Note that there may be a case in which a step may result between the respective outside surfaces of the front rocker molding piece 21 and the rear rocker molding piece 22, even if the front rocker molding piece 21 and the rear rocker molding piece 22 are assembled with an acceptable assembly tolerance. Even in this case, the front rocker molding piece 21 and the rear rocker molding piece 22 are not readily disassembled in this example, as the rear rocker molding piece 22 is not allowed to be displaced outward in this structure even if the surface of a stepped portion between the front rocker molding piece 21 and the rear rocker molding piece 22 faces forward and is subjected to impact from the front side of the vehicle, for example, due to wind pressure or stones etc. flying up from the road surface.

Assume here a structure that is reverse from the structure in this example, that is, a structure having a recessed portion formed on the rear end portion of the front rocker molding piece 21 and an extension portion formed on the front end portion of the rear rocker molding piece 22 so that the extension portion is fitted in the recessed portion. As this structure allows outward displacement of the rear rocker molding piece 22 in the case where the surface of the stepped portion between the front rocker molding piece 21 and the rear rocker molding piece 22 faces forward and is subjected to impact from the front side of the vehicle due to wind pressure or stones etc. flying up from the road surface, the front rocker molding piece 21 and the rear rocker molding piece 22 can be readily disassembled.

Note that the present disclosure is not limited to the above-described embodiment and its modified examples, but can be modified or improved in various manners without departing from the scope of the gist of the claims attached.

1. A rocker molding to be mounted on a vehicle so as to extend in a front-rear direction of the vehicle, wherein the rocker molding is composed of a front rocker molding piece to be mounted on a front side in the front-rear direction of the vehicle, and a rear rocker molding piece to be mounted on a rear side.

2. The rocker molding according to claim 1, wherein the rocker molding is made of resin.

3. The rocker molding according to claim 1, wherein
the front rocker molding piece has an extension portion formed on a rear end portion thereof, the extension portion extending inward in a width direction of the vehicle, and
the rear rocker molding piece has a recessed portion into which the extension portion is to be inserted.

4. The rocker molding according to claim 2, wherein
the front rocker molding piece has an extension portion formed on a rear end portion thereof, the extension portion extending inward in a width direction of the vehicle, and
the rear rocker molding piece has a recessed portion into which the extension portion is to be inserted.
